(19) United States
(12) Patent Application Publication
(10) Pub. No.: US 2011/0082755 A1
(43) Pub. Date: Apr. 7, 2011

(54) SYSTEM AND METHOD FOR PRESENTING AND METERING ADVERTISEMENTS

(76) Inventor: Oded ITZHAK, Hoboken, NJ (US)

(21) Appl. No.: 12/897,179

(22) Filed: Oct. 4, 2010

Related U.S. Application Data
(60) Provisional application No. 61/248,957, filed on Oct. 6, 2009.

(51) Int. Cl. G06Q 30/00

(52) U.S. Cl. 705/14.69; 705/14.73

(57) ABSTRACT

A system and method for providing advertisements or other content, for example on an Internet browser at a user computer. Advertisements may be received and presented at for example a user computer. A visibility duration of the advertisement may be measured. Presentation of an advertisement may be terminated upon determining that a visibility cap or threshold associated with the object has been reached.

### PRIOR APPLICATION DATA

The present application claims benefit of prior provisional application 61/248,957, filed on Oct. 6, 2009, entitled “SYSTEM AND METHOD FOR PAY PER TIME ONLINE ADVERTISING”, incorporated herein by reference in its entirety.

### BACKGROUND OF THE INVENTION

Internet display advertising often minors its printed media form. The most common Internet advertising pricing model, cost-per-thousand impressions or CPM (where the letter “M” in the abbreviation stands for the Roman numeral for one thousand), has also been adopted from the offline world. According to the CPM model, media for advertising campaigns is priced by sets of 1,000 impressions, and advertisers purchase multiple sets for each campaign. Other popular models for online advertising include CPC (cost per click), CPA (cost per action) and CPL (cost per lead). These models are typically used by direct-response marketers due to their performance-based, short-term revenue generating nature, and are less effective for branding.

However, CPM and other existing models fail to address important aspects of today's advertising industry that include complex advertising content such as multimedia, and sophisticated presentation methods. For example, unlike offline media, online impression inventory is almost infinite. Publishers can easily create impressions simply by adding more advertisement units to a page or breaking an article into multiple pages. When advertising is sold on an impression basis such as by the CPM model, publishers may inflate advertisement inventory by creating low-quality pages, such as photo galleries, auto-generated content, or single-paragraph summaries of third-party content. In addition, all impressions are not created equal. The CPM model and other models may be based on the assumption that an impression on a high-quality page is worth the same as an impression on a low-quality page. A cost or charge associated with an impression on a high quality page may not be different from an impression in a low quality page.

The CPM model allows publishers to generate fraudulent impressions. Publishers may artificially generate impressions by placing display advertisements in hidden iframes. Furthermore, advertisement networks and servers are typically unable to determine if advertisement requests are coming from real users, as opposed to crawlers or bots.

Another problem related to the CPM and other existing models is that advertisers often pay for impressions even if or when a related advertisement was not visible to or exposed to a potential customer, or is visible for a very short length of time. For instance, “below the fold” placements are not visible to a user unless the user scrolls down the full length of a web page. A right-rail advertisement unit might be out of the user's viewport (the rectangular area within the web page that is visible to the user as known in the art) or monitor when a browser's window is not maximized.

There is a need in the art for a system, method and/or device to enable determining an actual presentation of advertisement content to its intended audience, including a determination of the content's exposure and/or visibility level.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 depicts a schematic block diagram of an exemplary system according to embodiments of the invention;

FIG. 2 is a flowchart illustrating a method according to embodiments of the invention; and

FIG. 3 is a high level block diagram of an exemplary computing device according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

In one embodiment of the present invention, the amount of time that an advertisement or other content presented to a user on an Internet web page is actually visible to the user may be metered. An advertiser may pay for only the time the advertisement is presented to a user (or blocks of that time). Different standards for or ways of determining the advertisement is “visible” may be used and agreed upon. A limit or cap may be placed on viewing time, so that after a certain amount of time the advertisement is replaced with a different advertisement and/or the advertiser does not pay beyond the limit or cap time.

Embodiments of the invention may measure an exposure or visibility time of an advertisement or other content, and possibly billing, accumulating monies owed, or otherwise charging advertisers or content providers based on a parameter related to visibility or exposure. By paying for actual exposure time, in some cases advertisers do not pay more when pages are broken into multiple sub-pages; instead advertisers may be charged based on a real marketing impact of their advertising content, e.g., based on an actual exposure or visibility of their content to users. Relating a charge for a presentation of an advertisement to the time spent viewing it may motivate production of high quality pages due to associated higher revenues. A location of an advertisement in a page may be less relevant. For example, regardless of whether an advertisement is located “below the fold” or “above the fold”, the advertiser may be charged only if the advertisement is visible, e.g., if the page is scrolled down or up to expose the advertisement to a user. Moreover, as crawlers, bots or other non-human clients may not actually display content they request, serving content to such entities may not cause advertisers to be charged.

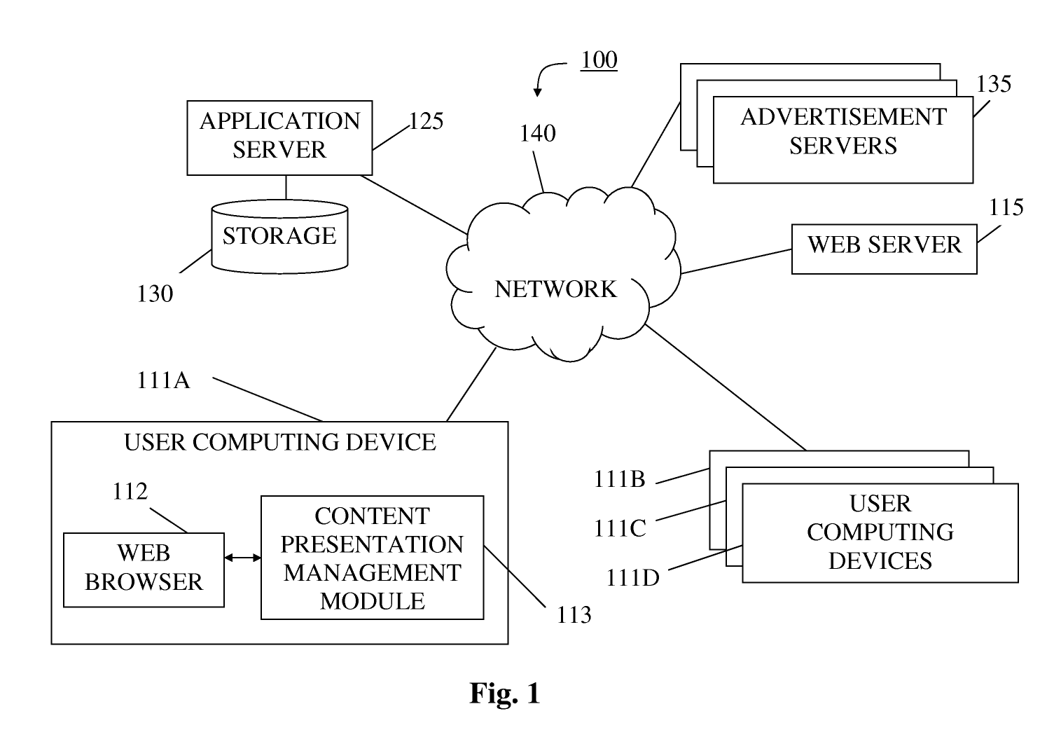

Reference is now made to FIG. 1, a block diagram of an exemplary system 100 according to embodiments of the invention. System 100 may include one or more network(s) 140 (e.g. the Internet), and one or more user computing device(s) 111A, 111B, 111C and 111D connected to network 140. Each of devices 111A, 111B, 111C and 111D may include a world wide web (web) browser 112 and a content presentation management module 113 (shown only within device 111A). System 100 may include a web server 115, an application server 125, a storage 130 operatively connected to application server 125 and advertisement servers 135. Computing device(s) 111A-D, web server 115, application server 125 and advertisement server 135 may all communicate by and send signals to each other via network 140. Network(s) 140 may be or include a private or public internet protocol (IP) network, the Internet, other networks, or a combination of networks.

User computing devices 111A-D may be client computing device(s), e.g., a computing device operated by an end-user viewing web content. Computing devices 111A-D may include, for example, personal computers, terminals, workstations, Personal Digital Assistants (PDAs), a cellular phones, etc.

Advertisement servers 135, web server 115 and application server 125 may be or may include any one or more suitable server computers as known in the art. Storage 130 may include, for example, a hard disk drive, a floppy disk drive, a Compact Disk (CD) drive, a CD-Recordable (CD-R) drive, or other suitable removable and/or fixed storage unit.

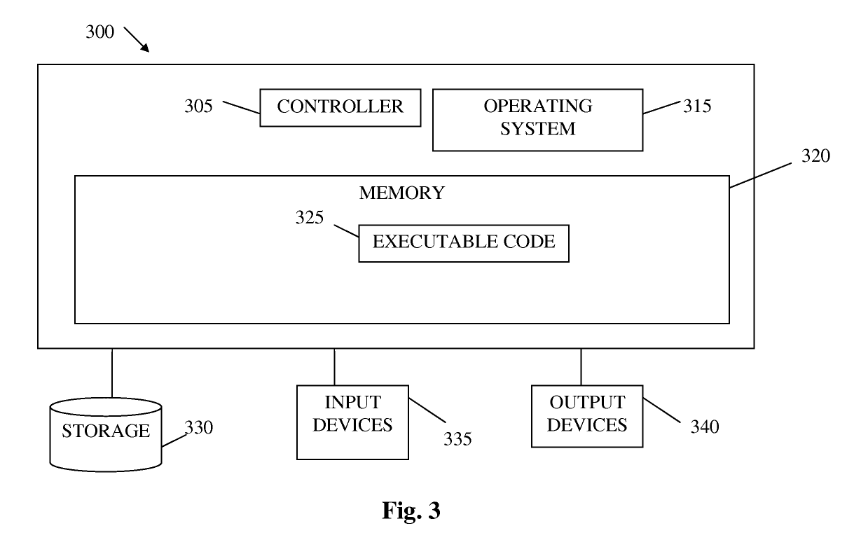

Advertisement servers 135, web server 115, application server 125 and user computing devices 111A-D may include a processor and a memory unit, and other units, as shown for example in FIG. 3.

Advertisement servers 135 may be advertisement servers as known in the art, accordingly, servers 135 may function and/or operate as known in the art, e.g., receive requests for content or content objects, e.g., advertisements or other messages, select advertisements to be provided and serve advertisements, e.g., to user devices 111A-D. Web server 115 may be a web server as known in the art and may, accordingly, support web sites, provide web pages or other content objects, handle hyper text transfer protocol (HTTP) and/or hyper text markup language (HTML), manipulate cookies or perform any operations related to a web server or application as known in the art. Web browser 112 may be any web browser, e.g., a commercial web browser or any module or application capable of receiving content objects and providing or presenting content to a user. Web browser 112 may receive and display, present or provide content received from web server 115, advertisement servers 135 and application server 125. (Data such as advertisements may be stored in, e.g., memory 320). Application server 125 may coordinate and record advertisement activity on web pages provided by web server 115 having advertisements provided by advertisement servers 135, and may allow, for example, accurate monitoring, metering and billing for advertisements or other messages actually viewed or displayed to users on computing devices 111. While different functions are described in the examples given as being performed by entities 111, 115, 125 and 135, in other embodiments, the functionality may be performed by different units, and functionality may be combined. For example, one server may both serve advertisements and meter, monitor, and bill based on advertisements that are actually visible. One server may both serve advertisements and content viewed by users containing the advertisements. Advertisements may be combined with content at a server and sent to a user device 111, rather than being combined at a device 111.

According to embodiments of the invention and as described herein, module 113 may be operatively connected to or may be included in web browser 112 and may measure or calculate parameters related to a visibility or exposure of an advertisement or message displayed by web browser 112. For example, module 113 may receive from web browser any HTTP data, information or packet. Module 113 may cause web browser 112 to request a specific content object or reload a web page. Module 113 may interact or communicate with web server 115, advertisement servers 135, user devices 111B-D and application server 125. Module 113 may compile a HTTP message or request (e.g., a GET request) and may cause web browser 112 to send the request, e.g., to web server 115. Module 113 may establish a transmission control protocol (TCP) connection with an application on one of servers 135, 115 or 125 and may communicate over such connection as known in the art.

Content presentation management module 113 may be or include, for example, executable code or a plug-in. For example, module 113 may include JavaScript which when executed by a processor (e.g., 305 in FIG. 3), perform methods according to an embodiment of the present invention. Module 113 may reside or be stored on user device 111A or it may be communicated to device 111A. For example, a software module comprising JavaScript or other executable code may be communicated from web server 115 to device 111A and may be executed on device 111A. In some embodiments, parts of module 113 may be stored locally on device 111A and other parts may be dynamically or otherwise received from a remote computing device, e.g., over network 140. Module 113 may be executed by for example controller or processor 305, and thus is may be considered that controller or processor 305 carries out part or all of a method according to embodiments of the invention.

In various embodiments, one or more thresholds may be used (possibly in combination), and one or more reporting methods may be used to report to a central server (e.g., server 125) visibility time, which may also be used for billing purposes. A user's computer (e.g. computer 111A) may check the visibility status of each advertisement on the page at fixed or variable intervals, and send, provide, submit or transmit to server 125 the aggregate or total visibility time (e.g., an amount of time), or a status indicating whether the advertisement is visible or not at the time of the test. In some embodiments, the visibility data is submitted to server 125 at fixed time intervals, for example once every one second, and may include a Boolean value (e.g., the advertisement is or is not visible). In such a case, server 125 may increase a visibility count or other measure of visibility (e.g., stored at server 125) for that advertisement by the time interval length. In some embodiments, module 113 calls server 125 in fixed intervals only when the tracked advertisement in visible. In other embodiments, module 113 submits visibility information to server 125 only on the occurrence of specific events, for example when the advertisement becomes visible, when the advertisement leaves the browser's viewport, when the window containing a page A looses focus, when the user navigates away from the page, when the browser is minimized, when another page element conceals the advertisement, etc. In such a case, module 113 may also send, provide or transmit the length of time that the advertisement was visible, either from the last call to server 125 or in aggregate. Any combination of the above methods can may be used. For example module 113 can submit visibility data to server 125 at fixed time intervals (for example one every 5 seconds) and also upon specific events.

In some embodiments, in order to determine that the advertisement is visible to the user, module 113 may check one or multiple conditions or events. For example, module 113 may check that the browser window that contains a page A holds the focus. The window looses the focus, for example, when the user switches to another application window, when the browser displaying page A is minimized or when the user is viewing another page in another tab on the browser. Module 113 may check that the advertisement is displayed within the browser viewport (e.g., the rectangular region within web page A that is visible to the user. Module 113 may check that there are no other page elements that conceal the advertisement or a portion of it. In some embodiments, module 113 may also check that the user is active on browser 112 by checking that the mouse has not been idle for a certain time period. For example, if module 113 determines that mouse hasn't moved for a certain length of time on browser 112, it may determine that the advertisement is not visible.

A page-view cap or threshold may be used to ensure that any individual advertisement cannot be visible to the same user on the same page-view for more than a certain amount of time, e.g., 1 minute. A time period cap or threshold may ensure that any individual advertisement cannot be visible to the same user across different pages or sites for more than a certain amount of time, e.g., 5 minutes during a 7 day period. In some embodiments, module 113 may request a new advertisement from advertisement server 135 when a page-view cap or a time-period cap is reached, and module 113 may then replace the advertisement with a new advertisement. For example, an advertiser can specify that all advertisements associated with a certain campaign should not be visible for more than 10 minutes in aggregate within a one week period across all websites. In some embodiments, when exposure time is capped, a remote server, such as server 125, or module 113 may store the exposure time information in a structure such as a cookie on the user computer. Advertisement server 135 may read the cookie upon receiving a request for advertisement(s) to determine if certain advertisement have reached their time exposure caps. In some embodiments, upon receiving exposure data from module 113, server 125 may store such data in storage 130. Such data may be used for billing and reporting purposes.

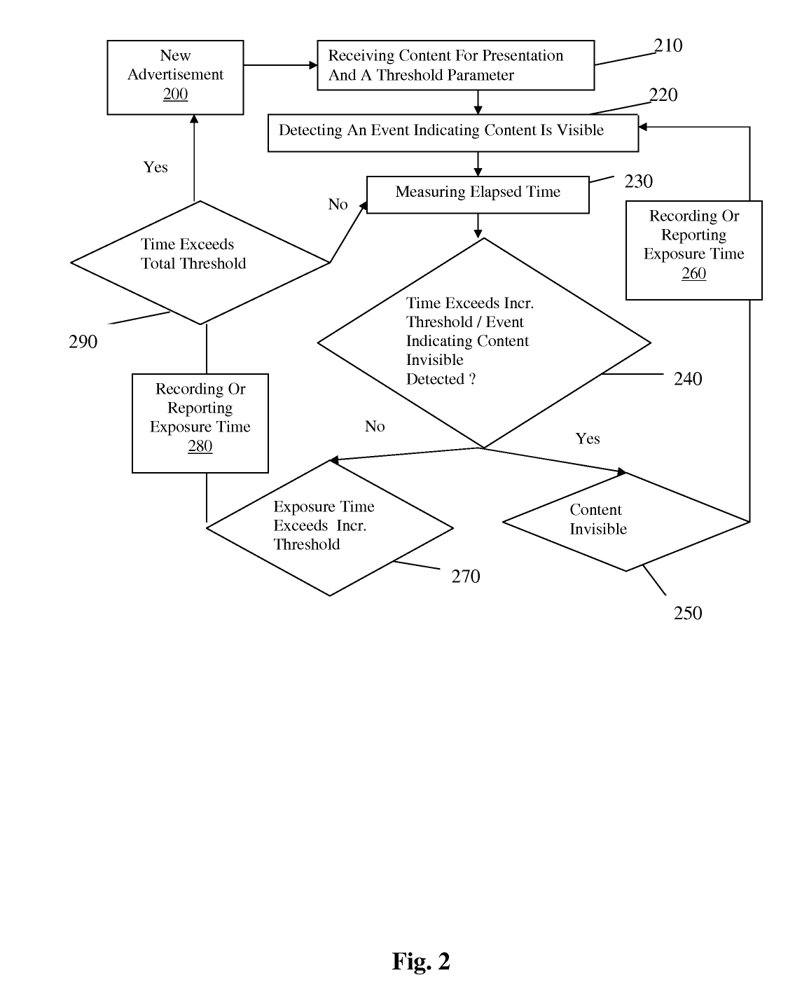

FIG. 2 is a flowchart illustrating a method according to embodiments of the invention. In block 200, an advertisement or other content may be received for presentation. For example, content may be received at a computer 111A when or after a user loads a web page from a web site with a web browser, from, e.g., web server 115. Typically, a user is viewing or requests to view a web page served by, e.g., server 115, and the web page when executed on user computer 111 requests an advertisement or other content from, e.g., server 135. The advertisement may be presented on or in association with a web page; for example the advertisement may be combined with the web page and presented to the user for viewing for example on a monitor or display of computer 111.

Other systems, software, and devices used for presenting content may be used, such as a smartphone, screens placed in public areas, etc. The advertisement may be displayed other than in or in association with a web page. Content received may include any type of content, data, parameters or executable code, e.g., as known in the art with respect to content communicated from a web server to a browser. For example, content may comprise graphical objects for display, multimedia for presentation and executable code such as binary code, or script such as JavaScript code segments. Content may be of any suitable type or format, e.g., jpg, png, gif, swf or jpeg. Typically, the content is delivered over network 140. Content described herein may be received from a web site or received content from a local storage or buffer. For example, a website may communicate a plurality of content objects to be presented, which may be stored or buffered locally.

A publisher of a web page's content may enroll in advance with a service or server (e.g., operated by server 125 or server 115) to receive executable code (e.g., Javascript or other suitable code) that may be in a programming language suitable for incorporation into websites. Executable code provided may be incorporated into a web page and may be delivered to a user's computing device and executed on the user's device. Module 113 may be implemented by code embedded in a web page provided to a user's device. For example, executable code such as JavaScript implementing management module 113 may be communicated from web server 115 to user computing device 111A and may perform any functionality described herein with reference to content presentation management module 113.

Module 113 or code implementing such unit may request content from a remote device. For example, content presentation management module 113 may request advertisement from servers 135 The advertisement may be stored in, for example, memory 320.

Upon receiving a request from content presentation management module 113 or browser 112, one of advertisement servers 135 may select one or more advertisements to serve to browser 112 based on, for example, targeting data, budget and other campaign data relating to each advertisement and/or campaign. A campaign may define, for example, times of day that the advertisement may be displayed, the maximum exposure time per user (for example in minutes) and per time period (for example, 10 minutes per week), the geographical locations of users that should be exposed to the advertisement etc.

Browser 112 may initiate a server-side call to load an external JavaScript file. The call may include parameters such as unit dimensions related to a specific object, e.g., an advertisement or banner, a publisher identification (ID), a unique resource locator (URL) related to a specific object, e.g., an advertisement to be embedded in a web page, a user device's address, e.g., an internet protocol (IP) address, an advertisement identification parameter, e.g., a unit ID and more. In some embodiments, Module 113 or other executable code or unit may write into a page an HTML division element or unit (herein referred to also as an “advertisement unit”) comprising a number of parameters, custom attributes or other information. Such parameters may comprise, for example, a threshold parameter as shown for example by block 210 that may indicate an advertisement's lifespan that may be, for example, a maximum number of seconds that the advertisement should be visible.

The server-side JavaScript or other executable code or unit may incorporate placeholders into a web page such as custom HTML attributes, e.g., the advertisement unit described herein, which may report various parameters, events or information. Placeholders may be or may contain, for example, an uptime that may be the actual time in second that the advertisement was visible on the page or a delta time that may be a number of seconds the advertisement was visible on the relevant page since the last time it was reported as visible. The server-side executable code may perform other tasks, e.g., compile the web page, insert content into the web page, e.g., image data or a Flash movie. An invisible tracking element, e.g., a 1×1 pixel object may be incorporated in the HTML division unit. Such an invisible pixel or element may be invisible to a user, e.g., it may not be rendered on a display or it may be rendered outside a visible area. Such invisible element may be used by a browser or module 113 to communicate to a server, e.g., web server 115, information related to a visibility time of a content object, e.g., an advertisement.

Content presentation management module 113 may include executable code embedded in a web page. Functions described herein as being executed by module 113 may in other embodiments be executed by other units. Upon loading a web page, a browser may call code implementing content presentation management module 113 embedded in the web page. The code may send a request for one or more advertisements to be displayed in the web page. An advertisement server, e.g., one of servers 135, may receive the request and may act according to parameters embedded in the request. For example, module 113 may include in a request for an advertisement any parameters or information, such as the number of advertisements requested, a publisher identification, a name or identification of the section or category of the page within the site, the IP address of the user viewing the page, information about the user's browser, geographic location of the user, descriptive information that describe the web page, user or client including, but not limited to, for example, a customer identification, a client identification code, a security code, the URL of the web page, a list of keywords or metadata from the web page as is known in the art, and/or content from the web page.

Parameters, such as parameters for governing advertisement metering, may be received with an advertisement or other content. Threshold or cap parameters may be received, for example a time related parameter or constraint. A threshold or cap parameter may indicate a time duration the content is to be visible, accessible or otherwise available to a user. For example, a threshold may indicate that the advertisement object is to be visible to a user for a duration of time of half a minute (30 seconds) before being swapped with another advertisement.

In block 220 an event may be detected indicating content is visible. In one embodiment, module 113 or a JavaScript code may initiate a monitoring function that may be set to run at fixed time intervals (e.g. every one second). The monitoring function may perform tasks such as determining a position of an advertisement unit within a web page, if the advertisement unit is currently within the viewport of a browser, e.g. if the advertisement unit is visible to the user, or determine if the browser window or the browser tab displaying the page with the advertisement holds the focus, is not minimized or is not in the background. Other parameters may be considered. Module 113 may determine the position of an advertisement unit within a web page, e.g., by interacting with web browser to receive relevant information. Module 113 may determine if the advertisement unit is not covered with any layered elements, and if the browser window has focus (e.g., is not minimized, not on the background). If all relevant conditions, requirements, criteria or other parameters are met an advertisement unit may be considered as visible. If used, a lifespan attribute described herein may be decreased by a predefined value (e.g., 1 to denote one second if the interval with which the relevant criteria are checked is one second) or a lifespan threshold increased. Similarly, uptime and delta parameters may be increased by one unit to reflect the fact that the content has been visible for the predefined interval.

An application program interface (API) may be used by module 113 in order to interact with a browser or operating system in order to obtain data, information or parameters such as a location of a banner or other advertisement within a browser window or viewport. If multiple browser tabs are used, module 113 may determine if a specific advertisement is in the active or visible tab or is currently in an invisible tab.

A visibility or availability of content to a user may be determined according to predefined criteria. For example, module 113 may determine that an advertisement is visible upon determining that a predefined portion of the advertisement is visible. For example, if more than fifty percent (or another percentage, e.g., over 40%, or over 70%) of an advertisement is within the viewport or monitor it may be considered visible. The web page display area of a web page holding the advertisement—the size of the web page—may be larger than the display area of the monitor. Alternatively or additionally, a predefined point, area or region may be checked within an advertisement and if the specific point or area is visible it may be determined the advertisement is visible. For example, a rectangular region in the center of an advertisement may be important to the advertisement. Other methods of determining visibility may be used.

In some embodiments, an advertisement may be displayed in a rich media format such as a movie or video clip. When such video advertisement is determined to become invisible to the user by module 113 (e.g. outside a viewport of a browser), module 113 may pause the video. For example, module 113 may determine the video clip is invisible and may further deactivate, e.g., pause playing the clip. Similarly, upon detecting that an object is visible, it may be reactivated, e.g. resume playing the clip. For example, when a region within which a video clip is contained is brought into the viewport of a browser, e.g., when a user scrolls down or up to expose the region containing the video clip, playing of the clip may be resumed or commenced.

Any suitable event indicating a content or object is visible to a user may be used to trigger or start measuring an exposure time. Exemplary events may be an entrance of an advertisement to a viewport, a focus change, a scroll down or up event, a window state change event or any event causing a previously invisible object to become visible.

In block 230, cumulative or aggregate time of visibility may be monitored and measured. The cumulative or aggregate time may be related to a visibility or availability of content to a user. For example, the time elapsing between a first event indicating the content is visible and a second event indicating the content is invisible may be measured. Such exposure time may be used to determine billing or a payment amount that an advertiser will pay for a presentation of advertisements, e.g., on a cost per exposure time basis.

In block 240, whether an exposure time exceeds a threshold and/or whether the content is no longer visible (e.g., it is invisible) may be checked.

If the content is determined to be invisible, the process may proceed to block 250. An event may be received indicating the advertisement is not visible to a user or viewer on a monitor; other methods of determining or detecting invisibility may be used. A process may define invisibility as simply the opposite of visibility; e.g., the browser window including the advertisement is minimized or blocked, or more than a percentage of the advertisement or a key area of the advertisement is no longer on the monitor or viewing pane. Events detected may include that browser's window no longer holds the focus, a user switched to another application window, a browser was minimized or a user switched to another page or tab on browser, an advertisement is located outside a browser's viewport, or another graphical or other element conceals the monitored object Other events triggering a determination of invisibility may include detecting or determining that mouse, other point and click device, keyboard or any interface device are idle for a predefined length of time, or activation or deactivation of applications. For example, an activation of a screen saver application may be interpreted by module 113 that an advertisement is invisible. Likewise, a deactivation of a screen saver application may indicate some advertisements are visible. Updating of counters (e.g., cumulative or aggregate time counters) that detect visibility of objects may be halted upon determining an object is not visible. A time period during which an object is loaded into a browser or other presentation application but is invisible may be recorded, reported and utilized as described herein with reference to other reported information.

In block 270, if the cumulative time an advertisement is visible exceeds an interim or incremental periodic threshold, the process may proceed to block 280. An interim periodic threshold may correspond to a unit of time (e.g., 1 second, 10 seconds), for which whenever the advertisement or message is exposed for that cumulative period of time, a signal is sent to a server, or a counter is increased. This may allow for incremental metering of cumulative exposure time.

In blocks 260 and 280, exposure time may be recorded (e.g., an internal counter of absolute time or a number of time periods passed may be updated) and/or reported, e.g., to a server such as server 125 or server 115. Recording of exposure time may be done by increasing or decreasing counters or by storing information, e.g., in a log file, memory location, database or in any applicable structure. In some embodiments exposure time may only be reported, or may only be recorded. The aggregated or cumulative length of time an advertisement is visible to users may be used to bill or charge the advertiser, or to accumulate monetary charges (e.g., stored in a memory 320) the advertiser owes related to the advertisement. The charges may relate to the cumulative amount of time the advertisement is displayed to a number of users.

Reporting or recording exposure time or other parameters may be periodic, e.g., every predefined or fixed length of time, by event, e.g., every time an object becomes invisible after being visible or upon an object reaching its visibility time limit, or by any combination thereof. Reporting may be done by various suitable methods. For example, module 113 may use TCP connections to directly report exposure times to a tracing application on application server 125 or server 115. Module 113 may store exposure time information in memory or in a cookie on a user's computer, e.g., one of devices 111A-D. Web server 115 or server 125 may read the cookie upon receiving a request for advertisements to determine if certain advertisements have reached their time exposure caps. Exposure time reported may be stored, for example, on storage 130. Advertisers may login, e.g. to server 125, and may be provided with information related to the actual exposure of their content. Visibility data may include a Boolean value (e.g., the advertisement is or isn't visible), a cumulative time, or other data. In some embodiments, a server may be notified in fixed intervals only when the tracked advertisement is visible. In other embodiments, visibility information may be sent to a server only on specific events, for example when the advertisement becomes visible, when the advertisement leaves the browser's viewport, when the window containing page A loses focus, when the user navigates away from the page, when the browser is minimized, when another page element conceals the advertisement, etc. The length of time that the advertisement was visible, either from the last report or in aggregate, may be reported.

Measuring elapsed time may be done with minimum intervals, e.g., 10 second intervals, 5 second intervals, etc. In this manner, very brief periods of “visibility”, where an advertisement is not visible for a practical amount of time, may be avoided or not recorded or used for billing. The time reported may be in multiples of fixed increments of time. For example, whenever the cumulative time exceeds an integral multiple of a pre-defined period, a signal or report may be sent to a remote server.

Reporting visibility data by module 113 may be occur upon specific events. For example, a report may be generated when an advertisement becomes visible, when the advertisement leaves the browser's viewport, when the window containing a web page loses focus, when the user navigates away from the page, when a relevant browser is minimized or terminated, or when another page element conceals the relevant or monitored advertisement etc. In some embodiments, reporting may be according to several paradigms, e.g., per event and periodically.

A report may include the event as well as other information or data, for example, accumulative exposure time until a specific event occurred, the time remaining until a cap time is reached etc. Information related to a presentation of an advertisement or other content such as, a time of day presented, number of clicks, click-through rates, a geographic location (e.g., of the user viewing the content), content type of a web page related to an advertisement reported etc. Reporting tools as known in the art may use information reported as described herein in order to provide detailed reports that may be used, e.g., by advertisers, publishers or others. Reports generated based on information produced, reported and recorded as described herein may enable advertisers or other interested parties to view performance data for any given time period, including exposure times, number of unique users, number of clicks, click-through rates, costs and performance. Publishers may also obtain effective-CPM data, which allows them to compare the performance of Cost-per-Time-measured units to similar CPM units.

Reports described herein and stored, e.g., on storage 130 may be used for billing. For example, a billing may be based on actual visibility time of content. Such unique billing capabilities may be made possible by embodiments of the invention based on data reflecting actual visibility of content gathered and stored as described herein.

If, in block 250, it was determined that the content was invisible, recording or time may be stopped, and the process may proceed to blocks 260 and 220, and when an event is detected indicating content is visible, the process may proceed as described above.

In block 290, it may be determined if the time an advertisement or other message has exceeded a total or cumulative time for being visible to a user. The cumulative time may be broken up into segments of time during which the segment was visible (which in some embodiments may have a minimum time period, but need not have this limit) If the cumulative visibility time for an advertisement does not exceed a threshold or cap, the process may proceed to block 230, where visibility time measurement may continue. The threshold or cap may be for a specific advertisement displayed to a user over a given time period (e.g. a cap of 1 minute over 24 hours) across different page, or the cap may be for a single page-view by a user (e.g. a cap of 30 seconds in a single page-view). The threshold or cap may in some cases be tied to a time period, for example the amount of time a specific advertisement is visible to a specific user (possibly across different pages or sites) is visible during a period (e.g., an advertisement cannot be visible to user A for more than 1 minute during a 24 hour period). User identification may be achieved by, for example, cookies, or other methods.

If the cumulative visible time for an advertisement exceeds a time threshold, in some embodiments, the process may proceed to block 200, where a new or replacement advertisement is requested and served in place of the previous advertisement, the process continuing to block 210. In some embodiments, a process such as that in block 290 need not be used, and a threshold for an advertisement or message need not be used.

Other operations or series of operations may be used. In addition, different features may be omitted from some embodiments (e.g., reporting each time period, using a minimum threshold period, changing advertisements after a certain period of time).

In some embodiments, a process such as module 113 may use an invisible pixel as a way to report visibility information, e.g., to server 125. For example, module 113 may dynamically create one or more image elements with a URL address pointing to server 125. Such URL may include parameters including but not limited to an identification parameter of the advertisement (e.g., advertisement or unit ID), an advertiser ID, a site ID and time exposure data. In order to submit information to web server 115, module 113 may invoke a request to browser 112 to reload the image or page, accordingly, browser 112 may send an appropriate request to server 125 where the request contains data placed therein by module 113 as described. Server 125 may processes the data placed in the request by module 113 and may return data to module 113 by sending a response containing an invisible image to be displayed in a web page. Although the invisible image may not be seen by a user, its communication may enable module 113 to communicate advertisement visibility information and additional data to server 115 by embedding such data or information in the response. Any other suitable technique that prompts browsers to request content from a web server as known in the art may be used.

Some embodiments of the invention may provide brand advertisers with powerful targeting capabilities, including geo-targeting, category-specific targeting, day-parting and advanced advertisement scheduling. In some embodiments, the aggregated length of time an advertisement is visible to users may be used to bill or charge the advertiser. For example, an advertiser can set up a campaign and pay a fee for exposure time, for example $10 per 1000 minutes that the advertisement is visible to users. This model may be referred to as Cost Per Exposure Time (CPET), or Cost Per Time (CPT). Advertisers can also set their own cost-per-time (CPT) rates per content category in an auction-based bidding system. For example, advertisers may cap the maximum length of time an advertisement is visible to a unique user, on a specific web page or in aggregate across multiple pages. Advertisers may not be required to pay for very short exposure times that do not allow a user to notice the advertisement and are deemed ineffective (for example, the user arrives at a web page by accident, and immediately leaves it for another site). The CPT model creates efficient brand exposure capping that may be much more valuable to the advertiser than traditional frequency capping currently available through CPM platforms or models.

Exposure capping also allows publishers to increase available inventory without adding more advertisement units to a page and/or without creating more web pages. When a CPT advertisement exceeds its pre-set exposure limit, a new advertisement may be served in its place—creating a new revenue opportunity for the publisher. In some embodiments, the advertiser can limit the exposure time of an advertisement or a set of advertisements by defining exposure caps. In some embodiments, advertisement exposure time may be measured and used in combination with other pricing models such as CPM. For example, advertiser may be charged on a CPM basis but may not be required to pay for advertisements with an exposure time below 10 seconds. Or, for example, advertiser will be charged a premium CPM rate for longer exposure times and a discounted CPM rate for shorter exposure times.

An exposure time or visibility time measured as described herein may relate to a specific advertisement or it may relate to a plurality of advertisements or other content objects. For example, an advertiser may specify that all advertisements associated with a certain campaign should not be visible on any one page for more than 5 minutes in aggregate. In such case, module 113 may update a common counter with relation to all advertisements related to the campaign and may further terminate a presentation of advertisements related to the campaign when a predefined exposure time, associated with the campaign is reached. Any grouping or association of content for the sake of exposure time may be implemented by embodiments of the invention. An advertiser may limit the length of time that an advertisement (or a set of advertisements) is displayed to a user on a multitude of web pages on any given site or across multiple sites, and within any given time period. For example, an advertiser can specify that all advertisements associated with a certain campaign should not be visible for more than 10 minutes in aggregate within a one week period across all websites. Module 113 may request a new advertisement from Advertisement Servers 135 when such time limit is reached.

For example, a lifespan attribute or parameter that may be periodically or otherwise decreased to reflect visibility time of an advertisement may reach a value of zero or a negative value, or may be increased beyond a threshold or cap. In such case it may be determined, e.g., by module 113, that the advertisement may no longer be presented as it has been visible for the predefined time. The advertisement may be replaced by another advertisement. In such a case, parameters or variables such as the “lifespan”, “uptime” and “delta” may be reset or updated in order to correctly reflect the new advertisement.

Reference is made to FIG. 3, showing high level block diagram of an exemplary computing device 300 according to embodiments of the present invention. Any of devices 111A-111D, web server 115, application server 125, and advertisement servers 135 may be or include a structure similar to the example of computing device 300 shown in FIG. 3. Computing device 300 may include a controller 305 that may be, for example, a central processing unit processor (CPU), a chip or any suitable computing or computational device, an operating system 315, a memory 320, a storage 330, an input device 335 and an output device 340.

Memory 320 may be or may include, for example, one or more of a Random Access Memory (RAM), a read only memory (ROM), a Dynamic RAM (DRAM), a Synchronous DRAM (SD-RAM), a double data rate (DDR) memory chip, a Flash memory, volatile or non-volatile memory, a cache, a buffer, or other suitable memory units or storage units.

Executable code 325 may be executed by controller 305 possibly under control of operating system 315. Executable code 325 may include, for example, browser 112, module 113, or software or code effecting various embodiments described herein. Storage 330 may be or may include, for example, a hard disk drive, a floppy disk drive, a Compact Disk (CD) drive, or other suitable removable and/or fixed storage unit.

Input devices 335 may be or may include a mouse, a keyboard, a touch screen or pad or any suitable input device. Output devices 340 may include one or more monitors, displays, speakers and/or any other suitable output devices. According to embodiments of the invention, servers 125, 135, and 115 and user devices 111A-D may comprise all or some of the components comprised in computing device 300 as shown and described herein.

Embodiments of the invention may include an article such as a computer or processor readable medium, a machine-readable medium, or a computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 320, computer-executable instructions such as executable code 325 and a controller such as controller 305 may be used to carry out methods described herein.

In some embodiments, a database or storage, e.g., storage 130 may store data, parameters or information relating to content such as advertisements, for example exposure time, number of impressions, number of page-views, number of clicks, click-through rate, number of unique users, cost, date and time. Such data may be stored or sorted according to any applicable criteria, e.g., per advertisement, per advertiser, per campaign, per page-view, per user, per publisher website, per page, etc. A reporting application, e.g., executed on application server 125, may enable advertisers to log in and view performance-related data per given time period, such as the number of advertisement impression served, total exposure time per advertisement, per campaign or according to other criteria, number of unique users, cost information that may be related to exposure or visibility time, number of clicks and click-through rate. Such reporting application may enable publishers to log in and view performance data per time period, such as number of advertisements served, exposure time, earnings, number of clicks, click-through rate, impressions and effective CPM. Reporting, storage and presentation of exposure time as described herein may enable calculating a sum to be paid for a presentation of content according to a duration parameter, e.g., actual exposure of content to potential customers.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of providing advertisements, the method comprising:
receiving, at a computing device, an advertisement;
presenting the advertisement on a web page, the web page displayed on a monitor;
monitoring the length of time the advertisement is visible to a user on the monitor;
billing an advertiser based on the amount of time.

2. The method of claim 1, wherein the monitoring comprises:
identifying a first event, said first event indicating the advertisement is visible to a user on the monitor; and
identifying a second event, said second event indicating the advertisement is not visible to a user on the monitor.

3. The method of claim 1, comprising:
if the amount of time exceeds a threshold, presenting a second advertisement in place of the advertisement.

4. The method of claim 1, wherein said billing comprises recording the amount of time.

5. The method of claim 1, wherein said monitoring comprises:
recording the cumulative amount of time the advertisement is visible to a user on the monitor, stopping the recording when the advertisement is not visible to a user on the monitor; and
when the cumulative amount of time increases beyond a certain time threshold, sending a signal to a remote server.

6. The method of claim 1, wherein the advertisement is visible to a user on the monitor when a certain percentage of the advertisement is visible to a user on the monitor.

7. The method of claim 1, comprising transmitting the length of time the advertisement is visible to a user on the monitor to a remote server.

8. The method of claim 7, wherein time is submitted at fixed time intervals, or upon the occurrence of an event.

9. The method of claim 1, wherein the monitoring is performed using an invisible pixel.

10. A system comprising:
a memory storing a received advertisement;
a controller to:
present the advertisement on a web page, the web page displayed on a monitor;
monitor the length of time the advertisement is visible to a user on the monitor; and
provide the amount of time to a server.

11. The system of claim 10, wherein the monitoring comprises:
identifying a first event, said first event indicating the advertisement is visible to a user on the monitor; and
identifying a second event, said second event indicating the advertisement is not visible to a user on the monitor.

12. The system of claim 10, wherein the processor is to:
if the amount of time exceeds a threshold, present a second advertisement in place of the advertisement.

13. The system of claim 10, wherein said billing comprises recording the amount of time.

14. The system of claim 10, wherein said monitoring comprises:
recording the cumulative amount of time the advertisement is visible to a user on the monitor, stopping the recording when the advertisement is not visible to a user on the monitor; and
when the cumulative amount of time increases beyond a certain time threshold, sending a signal to the server.

15. The system of claim 10, wherein the advertisement is visible to a user on the monitor when a certain percentage of the advertisement is visible to a user on the monitor.

16. The system of claim 10, wherein time is provided at fixed time intervals, or upon the occurrence of an event.

17. The system of claim 10, wherein the monitoring is performed using an invisible pixel.
